(19) United States
(12) Patent Application Publication
(10) Pub. No.: US 2025/0321152 A1
(43) Pub. Date: Oct. 16, 2025

(54) METHODOLOGY FOR IDENTIFYING LEAKS IN SWIMMING POOLS

(71) Applicant: Laise Maximiliano DANIEL, Buenos Aires (AR)

(72) Inventor: Laise Maximiliano DANIEL, Buenos Aires (AR)

(21) Appl. No.: 18/960,939

(22) Filed: Nov. 26, 2024

(30) Foreign Application Priority Data
Apr. 11, 2024 (AR) 20240100909

(51) Int. Cl. G01M 3/20

(52) U.S. Cl. CPC G01M 3/20

(57) ABSTRACT

Method for pool leak detection, comprising the steps of: (a) preparation of the pool: emptying the pool of water and allowing it to dry; (b) drilling of the pool bottom: drilling at least two separate holes in the bottom of the pool; (c) installation of passing plugs and connection to gas pipes: placing a passing plug in each hole, connected by an elastic hose to pressurized tubes containing tracer gas (95% nitrogen 5% hydrogen; (d) gas injection and diffusion: injecting the tracer gas through the pipes connected to the plugs. The gas will fill the space between the pool surface and the underlying floor; (e) surface gas detection: detecting and locating the presence of the gas at the pool surface with a tracer gas detector; and (f) leaks identification and marking: marking the location of leaks and recording the gas flow intensity.

### RELATED APPLICATION

This application claims priority from Argentina patent application Ser. No. 20240100909, filed Apr. 11, 2024, the entire disclosure of which is incorporated herein by reference.

### TECHNICAL FIELD OF THE INVENTION

This invention belongs to the field of methods for detecting pool leaks. The proposed method involves the use of a tracer gas to accurately identify and locate leaks in empty and dry pools. The method essentially involves making at least two separate holes in the bottom of the pool. A passing plug is then placed in each hole, through which the tracer gas will be injected to fill the closed space between the surface of the pool and the ground on which it is located. This gas will eventually penetrate any cracks or leaks in the pool. Finally, the presence of gas leaking through the pool surface is detected with a hydrogen detector. This allows for the exact location of leaks for effective pool repair and maintenance.

### PRIOR ART

There are various methods for leak detection in closed containers using tracer gases, as in the case of pipes and similar structures. However, conventional methods for pool leak detection, such as the use of tracer liquids or thermal imaging cameras, have serious limitations in terms of efficiency and accuracy. As for methods applicable to pipes or nuclear pools, patents FR2617285 and CN107449559 can be cited.

In practice, and in relation to swimming pools, the most widely used method is sometimes referred to as “liquid detect” or “dye testing”. This method is based on the use of a liquid and the participation of a person, a diver, who performs the work. The method is carried out with the pool filled with water. The diver submerges and begins to apply this tracer liquid (a dye with a striking color and special properties) at various points in the pool where a leak may be suspected. In case of a leak, this liquid automatically penetrates it. If there is no leak, this liquid simply dilutes in the water. Using this system takes about twelve hours on average, and largely depends on the skill and expertise of the diver performing the method. In addition, it does not allow for any graduation of the severity of the detected crack or leak. The conditions of the water and the pool structure affect the method accuracy. Therefore, it has a high margin of error, and its execution relies on the operator's skills.

Another known method is based on the use of thermal imaging cameras. The pool must be empty for this method. A thermal imaging camera is used to detect temperature variations in different parts of the pool, based on the premise that areas with lower temperatures than others may indicate the presence of a leak or water escape. Its execution can take anywhere from eight hours to several days, depending on the size of the area to be inspected. This premise is highly inaccurate, and the method is cumbersome and inefficient, leaving the final determination of whether leaks exist up to the operator based on the detected temperature variations.

In relation to the already known pool leak detection systems, the methodology claimed in this application is qualitatively superior for a wide number of reasons: (a) it detects leaks regardless of their size, (b) regardless of whether they are visible or not, (c) it can determine the severity and/or intensity of the leak with great accuracy (due to the flow of the tracer gas passing through), and d) all of the above, in a fraction of the time and at a significantly lower cost compared to similar methods.

Therefore, the purpose of this invention is to provide an efficient, fast and affordable method for detecting pool leak.

### DETAILED DESCRIPTION

This disclosure features a method for detecting leaks in pools installed on the ground. This method is suitable for pools made of masonry or reinforced concrete. Initially, the method will involve:
(1) Preparing the pool: it must be empty and dry.
(2) Drilling the bottom of the pool: at least two holes, spaced apart, will be drilled into the prepared floor of the pool. The size of the holes is variable, depending on the characteristics of the pool. A suitable hole size can be, for example, 16 millimeters in diameter and 60 centimeters in length. The first measurement will depend on the drilling equipment used, and the second on the thickness of the construction of the pool.
(3) Installation of passing plugs and connection to the gas pipe: once both drillings are completed, a passing plug is placed in each one, with the size depending on the diameter of the drilled hole (preferably 16 mm), and the size of the plug should be slightly smaller than that of the hole. A 14 mm passing plug is preferably used for a 16 mm hole, as it expands upon placement, sealing the respective hole.

Then, both plugs are connected, by means of a flexible hose, to a pressurized gas pipe, with a pressure regulator and a pressure gauge. A tracer gas to be used will circulate through this gas pipe.

The method further includes (4) a gas injection and diffusion step. In this step, the gas valve controlling flow through the gas pipe is opened, and the tracer gas is injected through the mentioned holes. The injection time will depend on the size of the pool, preferably between 5 and 10 minutes of circulation, at a pressure between 0.5 and 1 bar, for a pool measuring 10 meters long by 2.5 meters wide and 2 meters deep. The tracer gas will fill the closed space that exists between the pool structure and the ground where it is located.

At this point, it is worth considering one of the most important aspects of the method: the tracer gas is composed of 95% nitrogen and 5% hydrogen. Said composition ensures that the tracer gas is (a) inert: it does not easily react with other materials, especially since nitrogen is the main component of the mixture, ensuring that it will not react upon contact with the pool; (b) safe: at low concentrations, it causes no harm to living beings or the environment (in fact, both gases are present in the atmosphere), nor to the pool; and (c) non-flammable: at the described concentration, the gas is non-flammable, eliminating the possibility of causing harm or damage to the pool for this reason. The tracer gas also has the following properties: (d) hydrogen, present in 5% as a gas to be effectively traced, is highly diffusible due to its molecular mass, and easily detectable at low concentrations, allowing for detection with the correct equipment in cracks that may not even be visible to the naked eye; (e) high precision and sensitivity: hydrogen detectors are highly sensitive at low concentrations, allowing for precise detection; and lastly, (f) the tracer gas is an effective and low-cost gas: the first point is based on the previously mentioned attributes, and regarding the second, it is a highly affordable gas, making the method generally implementable at a lower cost compared to pre-existing methods.

For example, for the application in one preferred embodiment, we used a VARIOTEC® 460, commercially available from Sewerin, tracer gas detection equipment and a Hilti TE30™ drilling rig.

In an additional step (5), gas is detected on the surface. Once the tracer gas injection step is completed, due to the characteristics of the earlier described gas, the hydrogen, given its low molecular mass, will pass through any leaks and/or cracks that the structure may have, regardless of whether they are minor, major, visible, or not perceptible to the human eye. In other words, if the pool has any cracks, if the pool has any cracks they will be infiltrated by hydrogen. Once done, by methodically sweeping the surface of the pool with a hydrogen detection device, any leaks can be easily detected, allowing the operator to detect the location and intensity of the leak.

Next, in a step (6), leaks are identified and marked. Upon detecting hydrogen, the equipment emits an audible signal and displays the gas concentration on the screen, after which the operator will mark the area of interest and keep a record of the detected gas flow.

Once the surface sweeping step of the pool is completed with the detection equipment, a two-component chemical anchor (for a preferred embodiment, a Hilti chemical anchor was used) is employed to seal the holes made for gas injection.

The advantages of the method include: (a) speed and efficiency: it significantly reduces the time required for pool leak detection processes, and does it with superior precision compared to alternative methods, with virtually no margin for error; (b) cost-effectiveness: its cost is considerably lower than pre-existing methods; (c) safety and precision in locating leaks: it also involves the use of a gas of proven success, safety, and efficacy for leak detection in other technical areas, such as pipe repairs (a method better known as the pipe tightness test); and (d) ease of implementation: the method steps, as well as the use of a tracer gas detector, are standard and do not pose any difficulties or require special training.

In summary, the described method for leak detection shows multiple advantages that make it preferable over other methods, especially when precise, efficient, and safe leak detection is required in swimming pools.

What is claimed is:

1. A method for pool leak detection, comprising the steps of:
emptying the pool of water and allowing it to dry;
drilling the bottom of the empty pool at least in two separate places;
inserting a passing plug in each hole;
connecting the plugs to tubes containing tracer gas;
allowing the gas to flow in order to fill the closed space between the pool structure and the ground where it is located;
allowing the gas to penetrate through possible cracks or leaks in the pool surface;
detecting and locating the presence of the tracer gas on the pool surface with a tracer gas detector; and
marking the location and intensity of the leaks.

2. The method of claim 1, wherein the drilling is performed by a drilling rig of variable depth and diameter.

3. The method of claim 1, wherein the gas injection comes from a pressurized container.

4. The method of claim 1, wherein the gas is selected for its ability to penetrate through small openings and rise to the surface thereof.

5. The method of claim 4, wherein the gas is a mixture of hydrogen and nitrogen.

6. The method of claim 5, wherein the gas is a mixture of 95% nitrogen and 5% hydrogen.

7. The method of claim 5, wherein detecting the tracer gas is performed with hydrogen detector equipment.

8. The method of claim 7, wherein upon detecting hydrogen, the hydrogen detector equipment emits an audible signal and/or displays the gas concentration on a screen.
